(19) United States
(12) Patent Application Publication
(10) Pub. No.: US 2010/0125718 A1
(43) Pub. Date: May 20, 2010

(54) PARALLEL ANALYSIS OF TIME SERIES DATA

(75) Inventors: Tiankai Tu, Forest Hills, NY (US); Charles A. Rendleman, Princeton Junction, NJ (US)

Correspondence Address: OCCHIUTI ROHLICEK & TSAO, LLP, 10 FAWCETT STREET, CAMBRIDGE, MA, 02138, US

(73) Assignee: D.E. Shaw Research, LLC, New York, NY (US)

(21) Appl. No.: 12/617,768

(22) Filed: Nov. 13, 2009

Related U.S. Application Data
(60) Provisional application No. 61/114,667, filed on Nov. 14, 2008.

(51) Int. Cl. G06F 15/76; G06F 9/02; G06F 9/30; G06F 17/10

(52) U.S. Cl. 712/30; 703/2; 712/E09.002; 712/E09.016

(57) ABSTRACT

In one aspect, a method of processing time-ordered multi-element data uses a set of computational nodes. In some examples, hundreds or thousands of nodes are used. A set of portions of the data are accepted, for example, from a MD simulation system. Each portion of the data is associated with a corresponding computational node in the plurality of computational nodes, and each portion representing a distinct range of time. Instructions for processing the data are accepted. These instructions include one or more instruction specifying a set of times, a set of elements, an analysis function, and an aggregation function. The accepted data is redistributed from within the portions at each computational node to multiple computational nodes in the plurality of computational nodes, such that data for any element of the specified set of elements is localized to a particular computational node. At each computational node, the trajectory analysis function is applied to the data for each node localized at that computational node. The results of the applying the analysis function are aggregated at each of the computational nodes, including applying the aggregation function to the results.

### CROSS-REFERENCE TO RELATED APPLICATIONS

This application claims the benefit of U.S. Provisional Application No. 61/114,667 filed Nov. 14, 2008, the content of which is incorporated herein in its entirety.

### BACKGROUND

This invention relates to parallel analysis of time series data.

Large-scale simulations, for example, molecular dynamics (MD) simulations, can produce massive quantities of time series data, arranged in a sequence of frames, (atomic coordinates at a certain time) called a trajectory. Post-simulation analysis of the data is traditionally performed using sequential processing. As the largest MD simulations move beyond the realm of terascale and towards the petascale complexity, traditional sequential analysis methods are increasingly untenable. Existing data processing approaches for parallel analysis are not well adapted for use with matrices and multi-body time-series data, such as data produced by MD simulation.

Implementing a predefined set of analysis functions within a single, efficient parallel program is inadequate because the analysis needs of end-users (e.g., scientists) are highly varied. It is impossible to foresee all the required functionality and develop a one-size-fit-all parallel analysis program. Pushing the responsibility to fully specify the parallel computation approach to the end users is also not a feasible approach, because end-users may be typically trained in biology, chemistry, physics, or medicine. For example, such end-users may study MD trajectories, and are not necessarily experts in managing large data sets or writing scalable parallel analysis software.

### SUMMARY

In one aspect, in general, a method of processing time-ordered multi-element data uses a set of computational nodes. In some examples, hundreds or thousands of nodes are used. A set of portions of the data are accessed, for example, from storage for a MD simulation system. Each portion of the data is associated with a corresponding computational node in the plurality of computational nodes, and each portion represents a distinct range of time. Instructions for processing the data are accepted. These instructions include one or more instructions specifying a set of times, a set of elements, an analysis function, and an aggregation function. The accepted data is redistributed from within the portions at each computational node to multiple computational nodes in the plurality of computational nodes, such that data for any element of the specified set of elements is localized to a particular computational node. At each computational node, the analysis function is applied to the data for each node localized at that computational node. The results of applying the analysis function are aggregated at each of the computational nodes, including applying the aggregation function to the results.

Aspects can include one or more of the following.

Accepting instructions includes accepting one or more instructions for a programmable computational environment. The redistributing, applying of the analysis function, and aggregating the results are executed as part of executing the instructions.

The redistributing, the applying the analysis function, and the aggregating are repeated for multiple iterations, each iteration in accordance with the accepted instructions.

Accepting instructions includes accepting instructions specifying a data series for a specified set of times. In some cases, multiple data series are processed concurrently.

The data includes trajectory data. The trajectory data may be a form of data series or time series of multi-element data. The trajectory data may correspond to a specified molecule type. The analysis function may determine which of a plurality of molecules of the specified molecule type pass through a specified membrane. The aggregated results of applying the analysis function at each of the computational nodes may represent one or more of the following: a number, rate, or distribution of locations at which a plurality of molecules of the specified molecule type pass through a specified membrane.

The analysis function may determine one or more of the following: a number or rate of molecules reaching target locations. The analysis function may relate to a transitioning of a compound from a solid state to a dissolved state.

In another aspect, in general, a computation system for processing time-oriented multi-element data, the system comprising a plurality of computational nodes, each computational node configured to accept a plurality of portions of the data, each portion of the data associated with a corresponding computational node in the plurality of computational nodes, and each portion representing a distinct range of time; accept instructions comprising instructions specifying a set of times, a set of elements, an analysis function, and an aggregation function; redistribute data from within the portions at each computational node to multiple computational nodes in the plurality of computational nodes, such that data for any element of the specified set of elements is localized to a particular computational node; apply the analysis function to the data for each node localized at that computational node; and aggregate results of the applying the analysis function at each of the computational nodes, including applying the aggregation function to the results.

Aspects can include one or more of the following.

Accepting instructions includes accepting one or more instructions for a programmable computational environment; and the redistributing, the applying the analysis function, and the aggregating are each the result of accepted instructions.

The redistributing, the applying the analysis function, and the aggregating are repeated for multiple iterations, each iteration in accordance with the accepted instructions.

Configured to accept instructions specifying a data series for a specified set of times. In some cases, configured to process multiple data series concurrently.

Aspects can include one or more of the following advantages.

Computation time can be reduced by first redistributing the data before performing the data series computations.

Allowing a user to specify the desired data series (e.g., the elements and times) and the computations to perform on the data series (e.g., analyses and aggregation functions), without requiring the user to specify particular parallel programming techniques, provides the user with access to efficient computation. Specifying the desired data series and computations using specific instructions (e.g., primitives or built-in functions) in a programmable computation environment or using application programming interfaces for a computation system provides the user with an easy way of invoking the computations.

Other features and advantages of the invention are apparent from the following description, and from the claims.

### DESCRIPTION OF DRAWINGS

FIG. 1 is a diagram of data flow.

FIG. 2 is a flowchart.

FIG. 3 is a diagram of data flow.

FIG. 4 is a diagram of a computational system.

### DESCRIPTION

A molecular dynamics (MD) simulation can generate massive quantities of data, for example, representing the position and velocity of each atom in a simulation volume at each time step of a simulation. There is a need to interpret the data generated by the simulation. In general, parallel approaches to analyzing the large quantity of data described below may allow scientists to specify desired data analysis without requiring them to also specify specifics of how the computation for the analysis is to be parallelized. Although described below in the context of simulated data, the parallel approaches may also be used to analyze large quantities of real data (i.e., data that is not the result of a simulation).

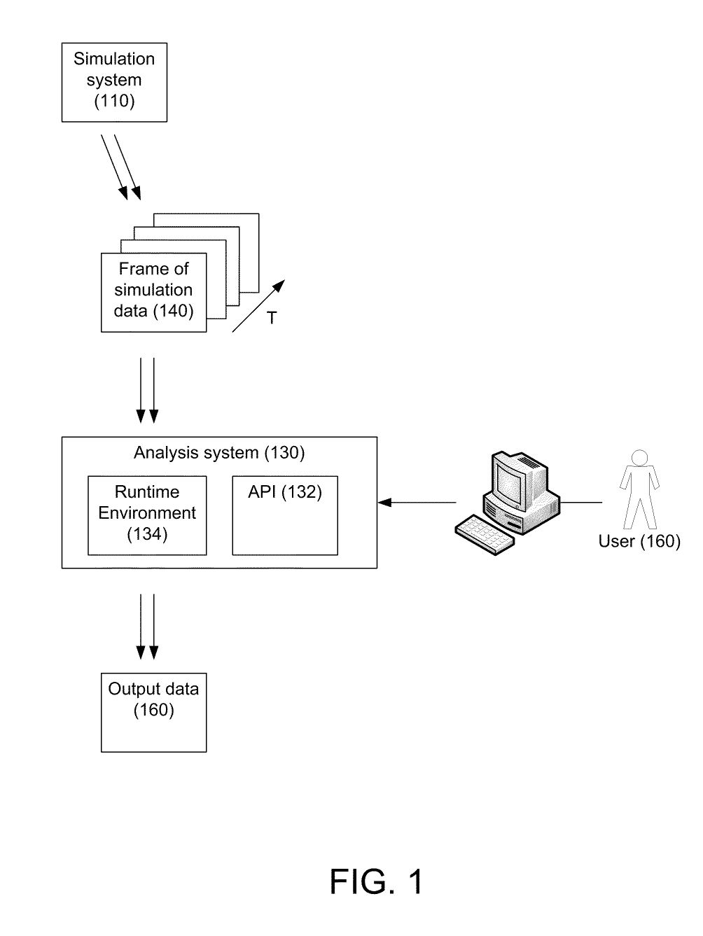

Referring to FIG. 1, an analysis system 130 implements a parallel analysis framework to analyze data generated by a MD simulation. In one embodiment, the parallel analysis framework includes an application program interface (API 132) that allows a user to specify trajectory analysis procedures using sequential operations, and a runtime environment 134 that carries out the parallel execution of the analysis procedures automatically. The parallel analysis framework can be implemented to allow users to define a trajectory of interest, carry out per-frame analysis, implement cross-frame analysis, aggregate intermediate results when necessary, and launch an analysis job and transfer control to the runtime environment.

In some examples, the simulation is run prior to data analysis on a simulation system 110 formed by a cluster of computation nodes (e.g., hundreds or thousands of computational nodes). In other examples, the simulation is run on a simulation system 110 consisting of a special-purpose parallel computer. Examples of algorithms and architectures for such simulations are described in US Pat. Pub. US 2006/0129363A1, “Orthogonal Method,” and US Pat. Pub 2008/0243452A1 “Approaches and Architectures for Computation of Particle Interactions,” which are incorporated herein by reference.

In some examples, simulation data generated by the simulation system 110 is passed from the simulation system 110 over the course of the simulation, and stored 120 as a collection of frames 140, each frame representing data for some or all of the simulation volume at a particular simulation time, or range of simulation times. The simulation data is stored, for example, on a network file system (NFS) or a parallel file system 120. In some examples, each frame of data is distributed to one of a set of nodes having storage and computation resources. At the completion of the simulation run, the data is stored in a centralized or distributed manner, arranged according to time frames. In some examples, most efficient access to the data is according elements (e.g., atoms, molecules) at a particular time, as compared to access of data over a set of times for a particular element (e.g., as data for a data series of an element over time).

Analysis of the data is generally performed by the analysis system 130 after the simulation has completed. In some examples, the analysis system 130 is formed by a commodity cluster with thousands of computational nodes, which may be the same as the computational nodes used for the simulation and/or may be the same nodes on which the simulation results were stored during the simulation run.

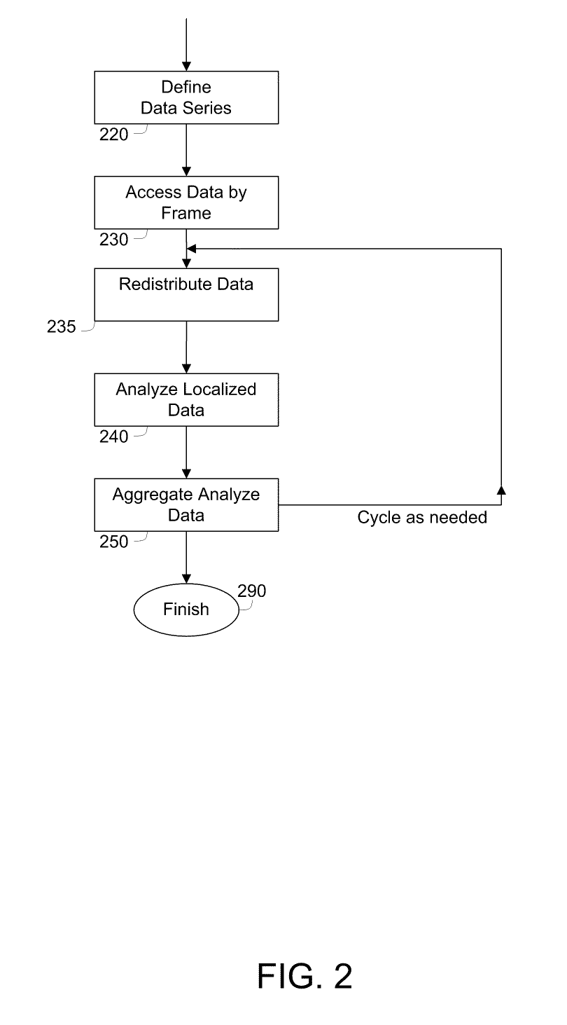

Referring also to FIG. 2, in an exemplary scenario, the frame data is loaded into storage accessible by the analysis system 130, for example, during the execution of the simulation. For example, frames are stored in a central repository, stored on a distributed file system, or distributed such that each node has access to or maintains a relatively equal-sized subset of the frames.

The user 150 defines (220) data series for analysis. The data series are defined by the elements of interest and the particular frames of interest. In some examples, the frames of interest are specified by the users as a start-time, end-time, and frame rate (stride).

The user also defines the computation that is to be performed for each trajectory, and the computation for aggregating the results of the trajectory specific computations.

In some examples, the user defines the data series and computations using the API to the parallel analysis framework. In some examples, the user defines the data series and computations using particular programming language statements (e.g., primitives or built-in functions) that are executed (e.g., interpreted, compiled, etc.) by a computation environment.

The analysis system 130 accepts the user's instructions and processes the frames according to the specified data series and computations. Each of a set of nodes of the analysis system 130 accesses (230) data for a set of frames assigned to that node. For example, each node accesses an equal share of the frames to be processed. Data is extracted from the frames for the elements of interest, optionally processed, and distributed (235) according to the specified data series. This distribution of the data results in data for each of the elements being localized in the distributed computation system, for example, with the data for each element being local to a single computation node.

Next, the extracted data is analyzed (240) locally at each computational node 240. The same computation is performed on the data for each of the extracted trajectories, with the result of each of the computations being held locally at the node at which the computation is performed.

Next, optionally, the results of the data series computations are aggregated (250), for example, according to the computation for aggregating the results specified by the user, and stored as output data 160.

In some examples, this process of redistributing, analyzing, and aggregating may be repeated. For example, the aggregated data is redistributed (235) according to the requirements of the next analysis cycle, which may be according to a key computed for each element trajectory. That is, at a first iteration, data is redistributed (235) according to a key associated with the identity of each particle. At subsequent iterations, redistribution (235) may be according to keys computed, for example, in step 240. When all of the task cycles have completed, the process is finished (290).

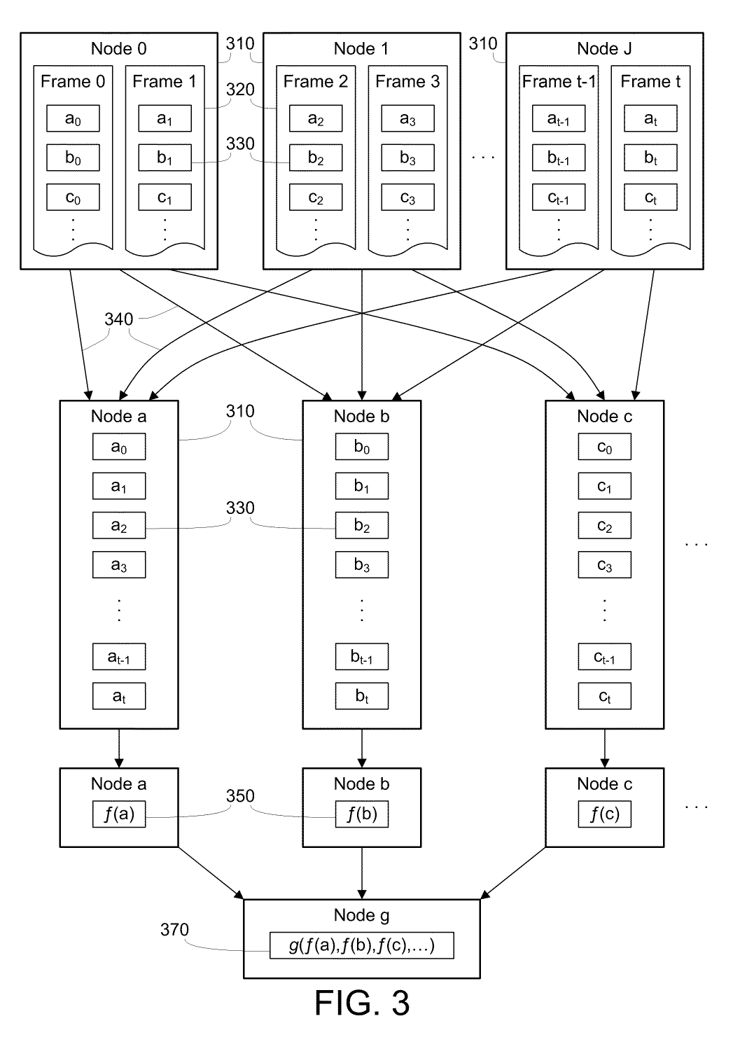

Referring to FIG. 3, in a simplified example usage, J nodes 310 are each allocated frames 320. Each frame 320 comprises data for each represented element 330 at the time associated with the frame. For example, Frame 3 is allocated to Node 1 and represents elements {a, b, c, . . . } at time 3. In a first distribution 340 (step 230 in FIG. 2), the data elements are redistributed such that each node is allocated data relevant to a particular element. Node a is allocated the data for elements a₀₋ₜ, node b is allocated the data for elements b₀₋ₜ, node c is allocated the data for elements c₀₋ₜ, and so forth. Each node performs a local computation (f(x)) 350 on the local data. The data is then aggregated, for example, to node g where further computations (g(x)) 370 are computed. Additional cycles of distributing, analyzing, and aggregating are repeated as desired.

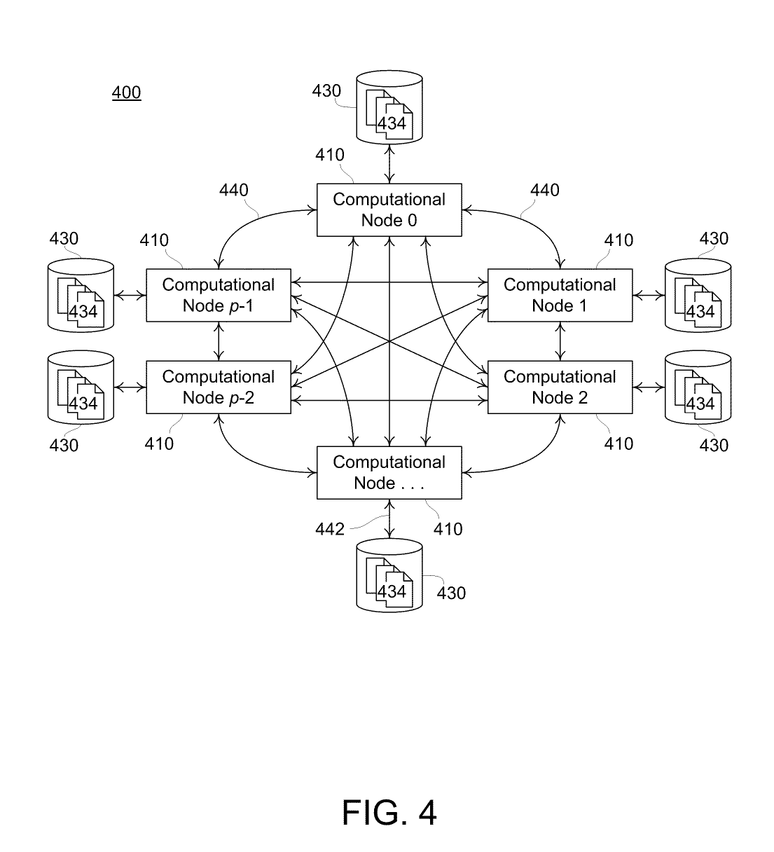

Referring to FIG. 4, an example embodiment of a computational system 400 includes many computational nodes 410. Each computational node 410 is associated with storage 430 where frames 434 allocated to the node are stored. While each node is shown as having distinct storage, the nodes may also use shared storage, for example, a network file system.

In some examples, the approaches described above are applied to problems in molecular simulation, for example, related to analysis of activity of pharmaceutical molecules and/or compounds. In one example, the trajectories of interest correspond to a specified molecule type and the analysis determines which of those identified molecules pass through a specified membrane. The overall result may include a number, rate, or distribution of locations at which the molecules pass through the membrane. In other examples, rather than analysis of transitions through a membrane, the specified analysis function may relate to the number or rate of molecules reaching target locations, such as receptors on target molecules. In yet other examples, the analysis may relate to transitions from solid to dissolved state of a compound.

It is to be understood that the foregoing description is intended to illustrate and not to limit the scope of the invention, which is defined by the scope of the appended claims. Other embodiments are within the scope of the following claims.

What is claimed is:

1. A method of processing time-ordered multi-element data using a plurality of computational nodes, the method comprising:
accessing a plurality of portions of the data, each portion of the data associated with a corresponding computational node in the plurality of computational nodes, and each portion representing a distinct range of time;
accepting instructions comprising instructions specifying a set of times, a set of elements, an analysis function, and an aggregation function;
redistributing data from within the portions at each computational node to multiple computational nodes in the plurality of computational nodes, such that data for each element of the specified set of elements is localized to a corresponding computational node;
at each computational node, applying the analysis function to the data for each node localized at that computational node; and
aggregating results of applying the analysis function at each of the computational nodes, including applying the aggregation function to the results.

2. The method of claim 1 wherein accepting the instructions comprises accepting one or more instructions for a programmable computational environment; and the redistributing, the applying, and the aggregating are each performed as part of executing the accepted instructions.

3. The method of claim 1 wherein the redistributing, the applying the analysis function, and the aggregating are repeated for multiple iterations, each iteration in accordance with the accepted instructions.

4. The method of claim 1 wherein accepting instructions comprises accepting instructions specifying a data series for a specified set of times.

5. The method of claim 4 further comprising processing multiple data series concurrently.

6. The method of claim 1 wherein the data includes trajectory data.

7. The method of claim 6 wherein the trajectory data corresponds to a specified molecule type, and wherein the analysis function determines which of a plurality of molecules of the specified molecule type pass through a specified membrane.

8. The method of claim 6 wherein the trajectory data corresponds to a specified molecule type, and wherein the aggregated results of applying the analysis function at each of the computational nodes represent one or more of the following: a number, rate or distribution of locations at which a plurality of molecules of the specified molecule type pass through a specified membrane.

9. The method of claim 1 wherein the analysis function determines one or more of the following: a number or rate of molecules reaching target locations.

10. The method of claim 1 wherein the analysis function relates to a transitioning of a compound from a solid state to a dissolved state.

11. A computation system for processing time-ordered multi-element data, the system comprising a plurality of computational nodes and configured to:
accessing a plurality of portions of the data, each portion of the data associated with a corresponding computational node in the plurality of computational nodes, and each portion representing a distinct range of time;
accept instructions comprising instructions specifying a set of times, a set of elements, an analysis function, and an aggregation function;
redistribute data from within the portions at each computational node to multiple computational nodes in the plurality of computational nodes, such that data for each element of the specified set of elements is localized to a corresponding computational node;
apply the analysis function to the data for each node localized at that computational node; and
aggregate results of the applying the analysis function at each of the computational nodes, including applying the aggregation function to the results.

12. The computation system of claim 11 wherein accepting instructions comprises accepting one or more instructions for a programmable computational environment; and the redistributing, the applying the trajectory analysis function, and the aggregating are each the result of accepted instructions.

13. The computation system of claim 11 wherein the redistributing, the applying the trajectory analysis function, and the aggregating are repeated for multiple iterations, each iteration in accordance with the accepted instructions.

14. The computation system of claim 11 wherein configured to accept instructions further comprises configured to accept instructions specifying a trajectory for a specified set of times.

15. The computation system of claim 14 further configured to process multiple data series concurrently.

16. The computation system of claim 11 wherein the data includes trajectory data.

17. The computation system of claim 16 wherein the trajectory data corresponds to a specified molecule type, and wherein the analysis function determines which of a plurality of molecules of the specified molecule type pass through a specified membrane.

18. The computation system of claim 16 wherein the trajectory data corresponds to a specified molecule type, and wherein the aggregated results of applying the analysis function at each of the computational nodes represent one or more of the following: a number, rate or distribution of locations at which a plurality of molecules of the specified molecule type pass through a specified membrane.

19. The computation system of claim 11 wherein the analysis function determines one or more of the following: a number or rate of molecules reaching target locations.

20. The computation system of claim 11 wherein the analysis function relates to a transitioning of a compound from a solid state to a dissolved state.
